(19) United States
(12) Patent Application Publication
(10) Pub. No.: US 2019/0018129 A1
(43) Pub. Date: Jan. 17, 2019

(54) SPEED DETECTION DEVICE AND COMMUNICABLE COUPLED VIRTUAL DISPLAY

(71) Applicant: APPLIED CONCEPTS, INC., Richardson, TX (US)

(72) Inventors: Stanley A. Walker, Flower Mound, TX (US); Wei-Jie He, Prosper, TX (US)

(73) Assignee: APPLIED CONCEPTS, INC., Richardson, TX (US)

(21) Appl. No.: 15/851,215

(22) Filed: Dec. 21, 2017

Related U.S. Application Data
(60) Provisional application No. 62/532,203, filed on Jul. 13, 2017.

(51) Int. Cl. G01S 13/58; G01S 17/58; G08G 1/052; G08G 1/017

(52) U.S. Cl. CPC G01S 13/589; G08G 1/017; G08G 1/052; G01S 17/58

(57) ABSTRACT

The present disclosure relates generally to client server communications and processing mechanism for use in a radar unit that can be mounted in a car, e.g. on the dash of the car, and a mobile computer that can be placed in a receptacle mounted, e.g., in the interior along the firewall of the car. The client server communications and processing mechanism enables communications between the units that can be one way, both ways, or a combination of both depending on the type of data needed to be communicated. The communications between the units includes speed tracking data and lock and release data.

### CROSS REFERENCE TO RELATED APPLICATION

This application claims priority to U.S. Provisional Patent Application No. 62/532,203, filed Jul. 13, 2017, entitled “Speed Detection Radar and Communicable Coupled Virtual Display,” the entire contents of which are hereby fully incorporated herein by reference for all purposes.

### BACKGROUND

The present disclosure relates to speed detection devices, such as RADAR and LIDAR detectors, and data processing modules associated therewith for controlling, communicating, and displaying detector device related data.

### SUMMARY

The present disclosure relates generally to a mountable radar detectors, e.g. LIDAR or RADAR detector, for use within police cruisers, a mobile and mountable computer, e.g. notebook, tablet, or handheld computer, and user interface applications and software algorithms that implement and execute processing and communications procedures for radar detection and associated data for remote display on the mobile and mountable computer.

In an embodiment, a system for managing and remotely displaying detection data of a speed measuring device is presented. The system comprises at least one storage resource for managing resources of the system at the speed measuring device and a personal computer that is communicatively coupled to the speed measuring device and has access to the speed measuring device storage resource. The speed measuring device processor executes application code instructions that are stored in the storage resource to cause the system to receive vehicle tracking data at the speed measuring device; store the tracking data at the speed measuring device in the storage resource; send the tracking data to the personal computing device; store the tracking data at the personal computing device in the personal computing device storage resource; and, display the tracking data at the personal computing device. In addition, the speed measuring device can be communicable coupled with the personal computing device over a peer to peer wired or wireless network.

In another embodiment, the speed measuring device processor can execute application code instruction to cause the system to automatically send tracking data to the personal computing device. The speed measuring device processor can also execute application code instruction to cause the system to receive an automatically generated lock command identifying select tracking data at the speed measuring device and send at least one of the select tracking data and a lock indicator to the personal computing device in response to receiving the automatically generated lock command.

In yet another embodiment, the speed measuring device processor can execute application code instruction to cause the system to receive a user initiated lock command identifying select tracking data and send the select tracking data and a lock indicator to the personal computing device in response to receiving the user initiated lock command. The speed measuring device processor can also execute application code instruction to cause the system to receive a lock command identifying select tracking data at the personal computing device and associate a lock indicator with the select tracking data in the storage resource in response to receiving a lock command. The lock command can be one of an automatically generated lock command and a user initiated lock command.

In another aspect, the speed measuring device processor executes application code instruction to cause the system to associate a lock indicator with select tracking data, in response to receiving a lock command, in the storage resource of at least one of the speed measuring device and the personal computing device. In response to the association of the lock indicator with the select tracking data in the storage resource, the tracking data displayed on the display of the personal computing device is select tracking data and is locked on the display. The speed measuring device processor can further execute application code instruction to cause the system to receive a release request and, in response, removing from storage a lock indicator associated with the select tracking data. The release request can be generated at one of the speed detection device or the personal computer and the lock indicator removed from storage is removed from the storage resource of at least one of the speed device or personal computer.

### BRIEF DESCRIPTION OF THE DRAWINGS

FIG. 1 is a block diagram depicting a computing platform of a police cruiser mounted radar detector and a computing platform of a mobile computer communicable coupled together to communicate radar detection data, according to certain example embodiments.

FIG. 2 is a flow diagram depicting an algorithm of a user interface and communication and processing procedures for a cruiser mounted radar, according to certain example embodiments.

FIG. 3 is a flow diagram depicting an algorithm of a user interface and communication and processing procedures for a mobile computing device, according to certain example embodiments.

### DETAILED DESCRIPTION OF PREFERRED EMBODIMENTS

The example embodiments presented herein are directed to systems, methods, and computer program products for use with either LIDAR or RADAR detectors. While the making and using of the example embodiments of the systems and computer program products are discussed in detail below, it should be appreciated that the systems and computer program products can be embodied in a wide variety of specific contexts. The example embodiments discussed herein are merely illustrative of specific ways to make and use the systems and computer program products and do not delimit the scope of the present invention.

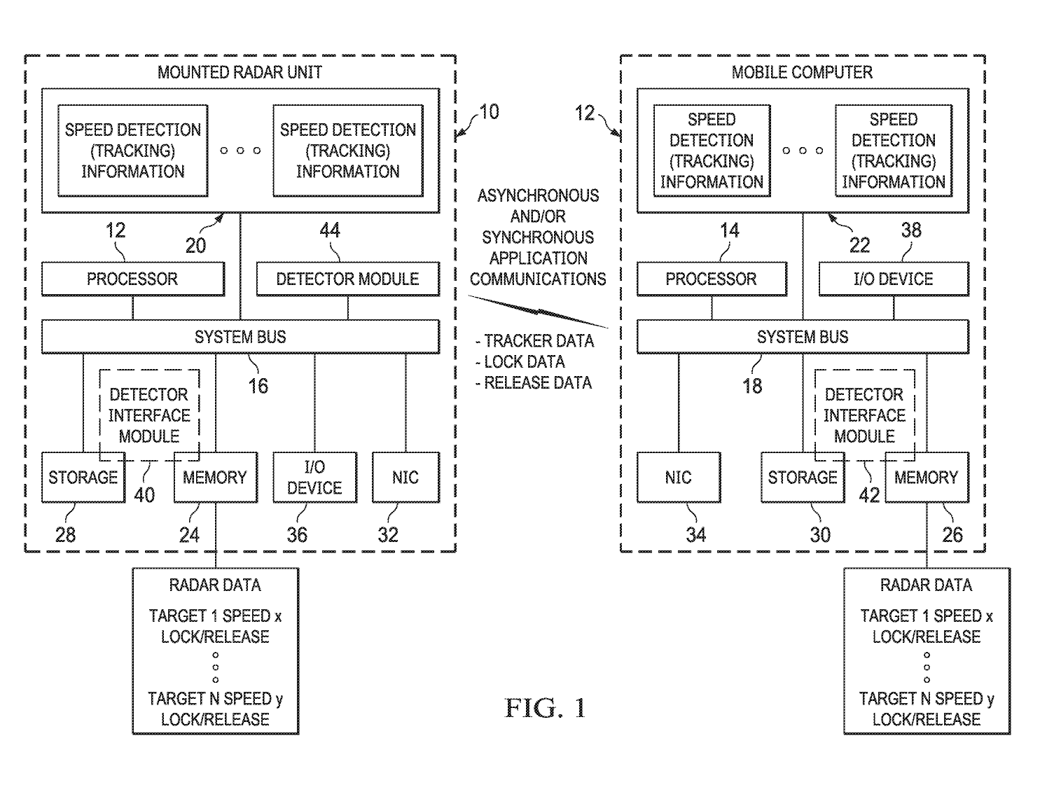

FIG. 1 is a block diagram illustrating a computing system 10 of a police cruiser mounted speed detector, or other types of detectors, such as a RADAR or LIDAR detector, and a computing system 12 of a mobile computer communicable coupled with the mounted detector to communicate speed detection data, according to certain example embodiments. Although, it should be understood that the mounted detector can also be a hand-held speed detection device. The system 10 and 12 can each include a processor 12, 14, system bus 16,18, a display 20, 22, e.g. touch screen displays, memory 24, 26, storage 28, 30, a Network Interface Card (NIC) 32, 34, other I/O device or devices 36, 38, such as keyboard, mouse, actuator buttons, etc., and a detector interface module 40, 42 for processing speed detector data. In addition, system 10 can also include speed detection module 44 communicable coupled with the detector interface module 40 and the necessary antenna ports 42 depending on whether the speed detection module 40 is a RADAR detector or a LIDAR detector. In addition, system 10 can include a minimum system environment that may not include the display 20 and other I/O controllers, such as actuator buttons or touch screen interfaces, and only the system components necessary to detect speed of a moving object, perform necessary calculations, and to communicate the data to system 12 so that a user can manage data from there. Furthermore, system 10 and 12 can also include various user space and kernel space applications that are a part of any open-source distribution or a packaged distribution from a proprietary source.

System 10 can communicable couple with system 12 over, e.g., a peer to peer connection, such as Bluetooth, or a Wi-Fi connection, or other suitable means for wireless communications. Although, an actual physical connection between system 10 and 12 can also be possible. The system 10 or 12 can establish a communications channel with the other in response to a user initiated command and/or automatically in response to the devices being in proximity, signal strength, and appropriate advertising data, such as an SSID for WLAN. Speed detection data can be communicated between the systems 10,12 using asynchronous communication applications, such as email or txt, or synchronous communication application, such as a streaming application service. In addition, communications can be unidirectional, i.e. from system 10 to system 12, or bidirectional, i.e. between both systems. The speed detection data can include only speed data and data associated therewith. The data associated with the speed data can include images, Doppler audio and video and GPS related data.

As the speed detection data and associated data is captured or determined at system 10, the data can be provided to the detector interface module 40 and either automatically communicated to system 12 or communicated to system 12 upon a user initiated lock command or an automatically generated lock command. A lock command can be automatically generated in response to the speed detection module 44 or the detector interface module 40 determining the speed data processed exceeds a threshold value above a speed limit value, e.g. a segment of highway that is marked as having a certain speed limit value either entered in by the officer operating the speed detection device or automatically entered by using GPS and other network services. The speed data processed can be processed solely from memory or from memory and storage and the speed data processed can either be stored permanently, or for a desired period of time, or can be flushed from memory and/or storage upon receiving a release command. The release command can either be issued by and from system 10 or 12. The system 12 can receive the data provided over the wireless interface and the detector interface module 42 can automatically display the results at display 22.

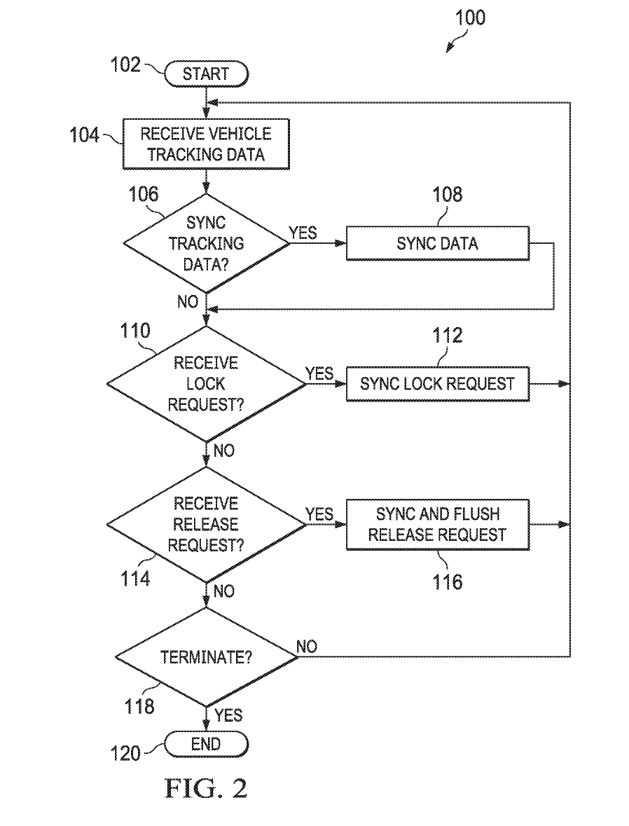

FIG. 2 is an illustration of a flow diagram for an algorithm of system 10 for processing and communicating speed detection data and other associated data for a police cruiser mounted RADAR or LIDAR detector, according to certain example embodiments, denoted generally as 100. The system begins at 100, e.g. upon user activation, powering up the detector, or receiving a notification that the speed detection data is ready for processing. At block 104, speed detection data and other associated data for a vehicle is received and if determined, at block 106, that the data should be automatically synched with remote system 12 the data is sent at block 108. It should understood that the decision to synch can be based on whether a user initiated such action or the system 10 automatically sends the data, e.g. when in an automatic mode. Otherwise, if the data is not automatically sent or sent in response to user request to system 12, algorithm 100 determines if a lock request has been received, at block 110. If it is determined that a lock request has been received, the lock request can be sent to system 12, at block 112, and then return to block 104 for further processing. Tracking data, i.e. speed detection data or other relevant data, such as images, Doppler audio, video, and GPS data, can be sent to system 12 at either block 108 or 112. Otherwise, the algorithm 10 can determine, at block 114, if a release request has been received. If determined so, the data can be flushed from the system and the request can be sent to system 12, block 116. The algorithm 100 can then return to block 104 for further processing. At block 118, algorithm 100 can determine if a terminate request has been received. The request can come from either system 10 or 12. The algorithm either ends at 120 or returns to block 104 for further processing. It should also be understood that many of the blocks of the algorithm described above can be optional. In other words, the system 10 can function to only receive speed detection data and other associated data, send the data to system 12, and terminate the algorithm 14, either upon a receiving a locally or remotely generated command. This application may be more practical for a streamlined system wherein the LIDAR or RADAR detector is a roof mounted unit that solely collects and determines vehicle speed data and communicates the data to the remote PC unit.

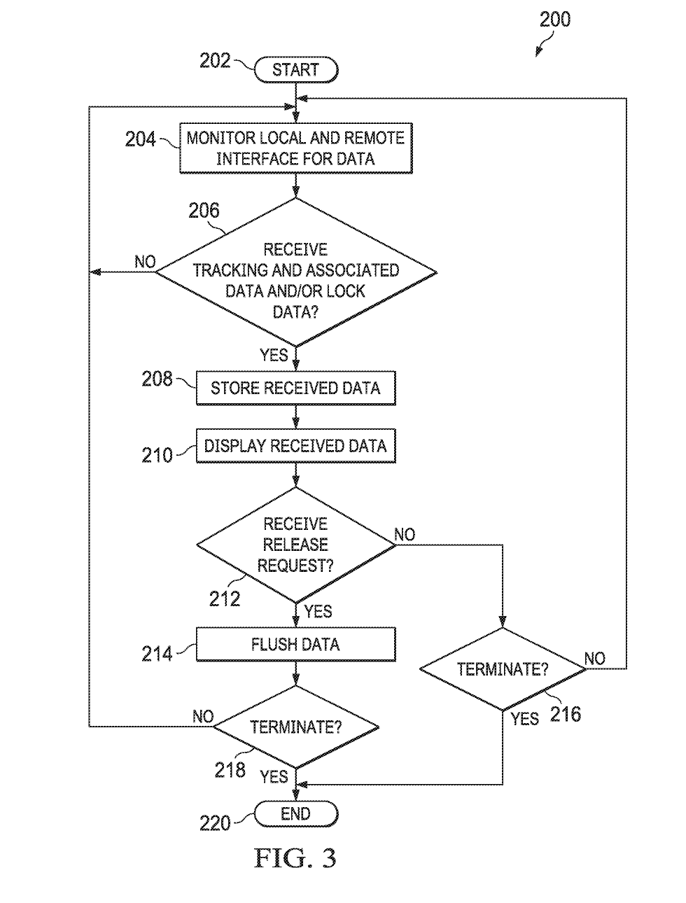

FIG. 3 is an illustration of a flow diagram for an algorithm for processing and communicating speed detection data and other associated data received from a police cruiser mounted RADAR or LIDAR detector, according to certain example embodiments, denoted generally as 200. The system 200 begins, block 202, upon powering up the system or awakening upon receiving a notification of received data. The algorithm 200 continues at block 204 where local and remote interface are monitored for speed detection and other related data. Although, it should be understood that the local interface can be a shared memory interface for inter process communications provided by a relevant operating system. At block 206, the algorithm 200 determines if tracking data (speed detection data), other associated data, and/or lock data is received over any of the monitored interfaces. If data is not received, the algorithm 200 returns to block 204 to continue monitoring the interfaces. If data is received, the data is stored, block 208, and displayed, block 210. If determined the received data includes a release request, block 212, the data is flushed from memory, block 214. If no release request is received, as determined at block 212, or if data has been flushed, block 214, it is determined if a terminate command has been received, blocks 216 and 218. If no terminate command has been received, the algorithm 200 returns to block 204. Otherwise, the algorithm 200 terminates, block 218.

In addition, it should be understood that in multi-threaded, multi-processor or multi-core based systems many of the algorithmic processes associated with FIG. 2 and FIG. 3 can be performed simultaneously.

Furthermore, the computing machines of system 10 and 12, the detector interface modules 40, 42 and other OS application modules, kernel and user space applications, can correspond to any of the various computers, mobile devices, laptop computers, servers, embedded systems, or computing systems presented herein. The detector interface modules 40, 42 and other OS application modules can comprise one or more hardware or software elements designed to facilitate the computing machines of system 10 and 12 in performing the various methods and processing functions presented herein. Each computing machine of system 10 and 12 can include various internal or attached components such as a processor 12, 14, e.g. each could include multiple processors and/or multiple cores, system bus 16, 18, system memory 24, 26, storage media 28, 30, input/output interface 36, 38, a network interface 32, 34 for communicating with a network, e.g. cellular/GPS, Bluetooth, WI-FI, a MEMS unit, which can include a gyroscope, and/or magnetometer and/or GPS, and LIDAR unit with appropriate laser sensors, and/or RADAR unit.

The computing machines can be implemented as a conventional computer system, an embedded controller, a laptop, a server, a mobile device, a smartphone, a wearable computer, a customized machine, any other hardware platform, or any combination or multiplicity thereof. The computing machines can be a distributed system configured to function using multiple computing machines interconnected via a data network or bus system.

The processor 12, 14 can be designed to execute code instructions in order to perform the operations and functionality described herein, manage request flow and address mappings, and to perform calculations and generate commands. The processors 12, 14 can be configured to monitor and control the operation of the components in the computing machines. The processors 12, 14 can be a general purpose processor, a processor core, a multiprocessor, a reconfigurable processor, a microcontroller, a digital signal processor (“DSP”), an application specific integrated circuit (“ASIC”), a controller, a state machine, gated logic, discrete hardware components, any other processing unit, or any combination or multiplicity thereof. The processor 12, 14 can be a single processing unit, multiple processing units, a single processing core, multiple processing cores, special purpose processing cores, co-processors, or any combination thereof. According to certain embodiments, the processor 12 along with other components of the computing machine 10 can be a software based or hardware based virtualized computing machine executing within one or more other computing machines.

The system memory 24, 26 can include non-volatile memories such as read-only memory (“ROM”), programmable read-only memory (“PROM”), erasable programmable read-only memory (“EPROM”), flash memory, or any other device capable of storing program instructions or data with or without applied power. The system memory 24, 26 can also include volatile memories such as random access memory (“RAM”), static random access memory (“SRAM”), dynamic random access memory (“DRAM”), and synchronous dynamic random access memory (“SDRAM”). Other types of RAM also can be used to implement the system memory 24, 26. The system memory 24, 26 can be implemented using a single memory module or multiple memory modules. While the system memory 24, 26 is depicted as being part of the computing machine, one skilled in the art will recognize that the system memory 24, 26 can be separate from the computing machine 10 without departing from the scope of the subject technology. It should also be appreciated that the system memory 24, 26 can include, or operate in conjunction with, a non-volatile storage device such as the storage media 28, 30.

The storage media 28, 30 can include a hard disk, a floppy disk, a compact disc read-only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 28, 30 can store one or more operating systems, application programs and program modules, data, or any other information. The storage media 28, 30 can be part of, or connected to, the computing machine. The storage media 28, 30 can also be part of one or more other computing machines that are in communication with the computing machine such as servers, database servers, cloud storage, network attached storage, and so forth.

The detector interface modules 40, 42 and other OS application modules can comprise one or more hardware or software elements configured to facilitate the computing machine with performing the various methods and processing functions presented herein, i.e. algorithms 100 and 200. The detector interface modules 40, 42 and other OS application modules can include one or more algorithms or sequences of instructions stored as software or firmware in association with the system memory 24, 26, the storage media 28, 30, or both. The storage media 28, 30 can therefore represent examples of machine or computer readable media on which instructions or code can be stored for execution by the processor 12, 14. Machine or computer readable media can generally refer to any medium or media used to provide instructions to the processor 12. Such machine or computer readable media associated with the detector interface modules 40, 42 and other OS application modules can comprise a computer software product. It should be appreciated that a computer software product comprising the detector interface modules 40, 42 and other OS application modules can also be associated with one or more processes or methods for delivering the detector interface modules 40, 42 and other OS application modules to the computing machine via a network, any signal-bearing medium, or any other communication or delivery technology. The detector interface modules 40, 42 and other OS application modules can also comprise hardware circuits or information for configuring hardware circuits such as microcode or configuration information for an FPGA or other PLD. In one exemplary embodiment, detector interface modules 40, 42 and other OS application modules can include algorithms capable of performing the functional operations described by the flow charts and computer systems presented herein for processing, managing, and communicating speed detection and other related data.

The input/output (“I/O”) interface 36, 38 can be configured to couple to one or more external devices, to receive data from the one or more external devices, and to send data to the one or more external devices. Such external devices along with the various internal devices can also be known as peripheral devices. The I/O interface 36, 38 can include both electrical and physical connections for coupling the various peripheral devices to the computing machine or the processor 12, 14. The I/O interface 36, 38 can be configured to communicate data, addresses, and control signals between the peripheral devices, the computing machine, or the processor 12, 14. The I/O interface 36, 38 can be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 36, 38 can be configured to implement only one interface or bus technology. Alternatively, the I/O interface 36, 38 can be configured to implement multiple interfaces or bus technologies. The I/O interface 36, 38 can be configured as part of, all of, or to operate in conjunction with, the system bus 16, 18. The I/O interface 36, 38 can include one or more buffers for buffering transmissions between one or more external devices, internal devices, the computing machine, or the processor 12, 14.

The I/O interface 36, 38 can couple the computing machine to various input devices including mice, touch-screens, scanners, electronic digitizers, sensors, receivers, touchpads, trackballs, cameras, microphones, keyboards, any other pointing devices, or any combinations thereof. The I/O interface 36, 38 can couple the computing machine to various output devices including video displays, speakers, printers, projectors, tactile feedback devices, automation control, robotic components, actuators, motors, fans, solenoids, valves, pumps, transmitters, signal emitters, lights, and so forth.

The computing machine can operate in a networked environment using logical connections through the NIC 32, 34 to one or more other systems or computing machines across a network. The network can include wide area networks (WAN), local area networks (LAN), intranets, the Internet, wireless access networks, wired networks, mobile networks, telephone networks, optical networks, or combinations thereof. The network can be packet switched, circuit switched, of any topology, and can use any communication protocol. Communication links within the network can involve various digital or an analog communication media such as fiber optic cables, free-space optics, waveguides, electrical conductors, wireless links, antennas, radio-frequency communications, and so forth.

The processor 12, 14 can be connected to the other elements of the computing machine or the various peripherals discussed herein through the system bus 16, 18. It should be appreciated that the system bus 16, 18 can be within the processor 12, 14, outside the processor 12, 14, or both. According to some embodiments, any of the processors 12, 14, the other elements of the computing machine, or the various peripherals discussed herein can be integrated into a single device such as a system on chip (“SOC”), system on package (“SOP”), or ASIC device.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions unless otherwise disclosed for an exemplary embodiment. Further, a skilled programmer would be able to write such a computer program to implement an embodiment of the disclosed embodiments based on the appended flow charts, algorithms and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the description herein.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

Although specific embodiments have been described above in detail, the description is merely for purposes of illustration. It should be appreciated, therefore, that many algorithms or aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

1. A system for managing and remotely displaying detection information of a speed measuring device, comprising:
a personal computer;
at least one storage resource for managing resources of the system at the speed measuring device wherein the speed measuring device processor is configured to execute application code instruction that are stored in the storage resource to cause the system to:
receive vehicle tracking data at the speed measuring device;
store the tracking data at the speed measuring device in the storage resource;
send the tracking data to the personal computing device;
receive the tracking data from the speed measuring device at the personal computing device;
store the tracking data at the personal computing device in the storage resource; and
display the tracking data at the personal computing device;
wherein the speed measuring device is communicable coupled with the personal computing device over a peer to peer wired or wireless network.

2. The system of claim 1 wherein the processor is configured to execute application code instruction to cause the system to send the tracking data further includes application code instruction to cause the system to automatically send tracking data to the personal computing device when a speed associated with a first vehicle is greater than a speed limit and to display unlocked speed data of a second vehicle.

3. The system of claim 1 wherein the processor is configured to execute application code instruction to cause the system to send the tracking data further includes application code instruction to cause the system to:
receive an automatically generated lock command identifying select tracking data at the speed measuring device for a first target and to allow continued tracking of speed data for a second target; and
send the select tracking data and a lock indicator to the personal computing device in response to receiving the automatically generated lock command and displaying the select tracking data and lock indicator.

4. The system of claim 1 wherein the processor is configured to execute application code instruction to cause the system to send the tracking data further includes application code instruction to cause the system to:
receive a user initiated lock command from the personal computing device identifying select tracking data for one of two or more vehicles; and
send the select tracking data and a lock indicator to the personal computing device in response to receiving the user initiated lock command for the one of the two or more vehicles while displaying tracking speed data for at least one of the two or more vehicles.

5. The system of claim 1 wherein the processor is configured to execute application code instruction to cause the system to:
receive a lock command identifying select tracking data for one of a plurality of vehicles at the personal computing device; and
associate a lock indicator with the select tracking data for the one of the plurality of vehicles in the storage resource in response to receiving a lock command;
wherein the lock command is one of an automatically generated lock command and a user initiated lock command.

6. The system of claim 1 wherein the processor is configured to execute application code instruction to cause the system to associate a lock indicator with select tracking data for one of a plurality of vehicles, in response to receiving a lock command, in the storage resource of at least one of the speed measuring device and the personal computing device while displaying tracking speed data for at least one of the plurality of vehicles.

7. The system of claim 6 wherein in response to the association of the lock indicator with the select tracking data in the storage resource the tracking data displayed on the display of the personal computing device is select tracking data and is locked on the display for one of the plurality of vehicles and active speed data is displayed for another of the plurality of vehicles.

8. The system of claim 6 wherein the processor is configured to execute application code instruction to cause the system to:
receive a release request and, in response, removing from storage a lock indicator associated with the select tracking data for a first vehicle from a display that is displaying tracking speed data for another vehicle;
wherein the release request is generated at one of the speed measuring device or the personal computer and the lock indicator removed from storage is removed from the storage resource of at least one of the speed device or personal computer.

9. A computer aided method of a system for managing and remotely displaying detection information of a speed measuring device, the method comprising:
receiving vehicle tracking data at the speed measuring device;
storing the tracking data at the speed measuring device in the storage resource;
sending the tracking data to the personal computing device;
receiving the tracking data from the speed measuring device at the personal computing device;
storing the tracking data at the personal computing device in the storage resource; and
displaying the tracking data at the personal computing device;
wherein the speed measuring device is communicable coupled with the personal computing device over a peer to peer wired or wireless network.

10. The computer aided method of claim 9 wherein sending the tracking data to the personal computer further comprises automatically sending tracking data to the personal computing device for each of a plurality of vehicles.

11. The computer aided method of claim 9 wherein sending the tracking data to the personal computer further comprises:
receiving an automatically generated lock command identifying select tracking data at the speed measuring device for one of the plurality of vehicles; and
sending at least one of the select tracking data and a lock indicator to the personal computing device in response to receiving the automatically generated lock command for the one of the plurality of vehicles and displaying the lock indicator and locked tracking data for the one of the plurality of vehicles while displaying active tracking data for another of the plurality of vehicles.

12. The computer-aided method of claim 9 wherein sending the tracking data to the personal computer further comprises:
receiving a user initiated lock command identifying select tracking data for one of a plurality of vehicles; and
sending the select tracking data and a lock indicator to the personal computing device in response to receiving the user initiated lock command for the one of the plurality of vehicles.

13. The computer-aided method of claim 9 further comprises:
receiving a lock command identifying select tracking data at the personal computing device for each of a plurality of vehicles at different times; and
associating a lock indicator with the select tracking data in the storage resource in response to receiving a lock command for each of the plurality of vehicles at the time associated with each vehicle;
wherein the lock command is one of a automatically generated lock command and a user initiated lock command.

14. A non-transitory computer readable medium containing computer readable instructions for instructing a first and second computing machine to manage and remotely display speed detection information of a speed measuring device, the computer-readable instructions comprising instructions for causing the computing machine to:
receive vehicle tracking data at the speed measuring device;
store the tracking data at the speed measuring device in a storage resource;
send the tracking data to the personal computing device;
receive the tracking data from the speed measuring device at the personal computing device;
store the tracking data at the personal computing device in a storage resource; and
display the tracking data at the personal computing device;
wherein the speed measuring device is communicable coupled with the personal computing device over a peer to peer wired or wireless network.

15. The non-transitory computer readable medium of claim 14 further includes computer readable instruction to cause the computing machine to send the tracking data further includes application code instruction to cause the system to automatically send tracking data to the personal computing device for each of a plurality of vehicles.

16. The non-transitory computer readable medium of claim 14 further includes computer readable instruction to cause the computing machine to:
receive an automatically generated lock command identifying select tracking data at the speed measuring device from a plurality of tracking data associated with a plurality of vehicles; and
send at least one of the select tracking data and a lock indicator to the personal computing device in response to receiving the automatically generated lock command for only one of the plurality of vehicles while continuing to display the tracking data for the other of the plurality of vehicles.

17. The non-transitory computer readable medium of claim 14 further includes computer readable instruction to cause the computing machine to:
receive a user initiated lock command identifying select tracking data for one of a plurality of vehicles; and
send the select tracking data and a lock indicator to the personal computing device in response to receiving the user initiated lock command from the personal computing device for the one of the plurality of vehicles.

18. The non-transitory computer readable medium of claim 14 further includes computer readable instruction to cause the computing machine to:
receive a lock command identifying select tracking data for one of a plurality of vehicles at the personal computing device; and
associate a lock indicator with the select tracking data in the storage resource in response to receiving a lock command for the one of the plurality of vehicles while not locking another of the plurality of vehicles;
wherein the lock command is one of an automatically generated lock command and a user initiated lock command.

19. The non-transitory computer readable medium of claim 14 further includes computer readable instruction to cause the computing machine to: associate a lock indicator with select tracking data for one of the plurality of vehicles, in response to receiving a lock command, in the storage resource of at least one of the speed measuring device and the personal computing device and to display tracking speed data for another of the plurality of vehicles.

20. The non-transitory computer readable medium of claim 19 wherein in response to the association of the lock indicator with the select tracking data in the storage resource for the one of the plurality of vehicles, the tracking data displayed on the display of the personal computing device is select tracking data and locked on the display while the tracking speed data for the another of the plurality of vehicles is not locked on the display.
